(19) United States
(12) Patent Application Publication
(10) Pub. No.: US 2012/0119959 A1
(43) Pub. Date: May 17, 2012

(54) PORTABLE RADIO COMMUNICATION DEVICE

(75) Inventors: Nobuharu Mashima, Kanagawa (JP); Hiroaki Ohmori, Miyagi (JP); Kenichi Sato, Miyagi (JP); Hironori Kikuchi, Miyagi (JP); Daigo Imano, Miyagi (JP); Yasunori Komukai, Miyagi (JP)

(73) Assignee: PANASONIC CORPORATION, Osaka (JP)

(21) Appl. No.: 13/386,345

(22) PCT Filed: Jun. 8, 2011
(86) PCT No.: PCT/JP2011/003221

§ 371 Date: Jan. 20, 2012

(30) Foreign Application Priority Data
Jun. 8, 2010 (JP) 2010-131241

(51) Int. Cl. H01Q 1/24

(52) U.S. Cl. 343/702

(57) ABSTRACT

A portable radio communication device includes a first circuit board provided in a first housing, first and second radio frequency sections provided on the first circuit board, a first power supply section that supplies power from the first radio frequency section to a core wire of a coaxial cable, a second power supply section that supplies power from the second radio frequency section to an outer conductor of the coaxial cable, and an antenna element provided in the first housing. One end portion of the outer conductor is connected to a ground pattern of the first circuit board via a first reactance element, and the other end portion of the outer conductor is connected to the ground pattern of the first circuit board via a second reactance element.

### TECHNICAL FIELD

The present invention relates to a portable radio communication device that can execute a plurality of radio communication applications such as, particularly, a GPS (Global Positioning System), a Near Field Communication, a wireless LAN (Local Area Network), a television broadcasting and the like.

### BACKGROUND ART

In the recent years, a portable radio communication device has many antenna elements necessary for mounting a plurality of radio communication applications. In addition, since an input device such as a touch panel or the like has come on the market, a liquid crystal display section and an operation section can be commonly achieved by a single device so that a portable radio communication device formed by a first housing is increasing. The antenna elements are usually built in the portable radio communication device.

In the above case, in order to effectively use an empty space in the housing, a coaxial cable is sometimes used for supplying power from a radio frequency section to an antenna element.

In addition, in a folding type portable radio communication device in which an upper housing and a lower housing are coupled to each other so as to be opened and closed, there is a case where it is preferable that an antenna element is arranged in the upper housing having, mounted thereon, a liquid crystal display section in consideration of a performance required for a radio communication application and a usage scene. For example, a GPS can be listed as such an application.

On the other hand, since a battery has a large occupancy rate with respect to a size of a device body, the battery is usually arranged in the lower housing different from the housing of the liquid crystal display section. In the case where the battery is arranged in the lower housing, the radio frequency section is usually also arranged in the lower housing. In addition, in the case where the radio frequency section is arranged in the lower housing, a coaxial cable is usually used for supplying power to the antennal element arranged in the upper housing.

Meanwhile, there is a proposal that in a case where a coaxial cable is used, the coaxial cable is used for supplying power to an existing conductor and the existing conductor and the coaxial cable are allowed to operate as an antennal (e.g., see Patent Document 1) or a part of the coaxial cable is used instead of a micro strip line so as to control spurious emission (e.g., see Patent document 2).

### PRIOR ART DOCUMENTS

### Patent Documents

Patent Document 1: JP-A-2006-086875

Patent Document 2: JP-A-2007-088864

### SUMMARY OF INVENTION

### Problems that the Invention is to Solve

Meanwhile, since a plurality of radio communication applications are installed on a portable radio communication device in the recent years, the portable radio communication device has many antennas, which results in a problem that reduction in size and in thickness of a body of the portable radio communication device is blocked.

The invention is made in view of the above circumstances, and the purpose of the invention is to provide a portable radio communication device that allows a plurality of applications to be installed therein while reduction in size and in thickness is achieved.

### Means for Solving the Problems

A portable radio communication device according to the invention, that is formed of a first housing, includes a first circuit board provided in the first housing, a first radio frequency section provided on the first circuit board, a second radio frequency section provided on the first circuit board, a first power supply section that supplies power from the first radio frequency section, a second power supply section that supplies power from the second radio frequency section, an antenna element provided in the first housing, and a coaxial cable that electrically connects the first power supply section to the antenna element. The coaxial cable has a conductive core wire and a conductive outer conductor arranged on a periphery of the core wire, the first power supply section supplies the power to the core wire of the coaxial cable, the second power supply section supplies the power to the outer conductor of the coaxial cable, and one end portion of the outer conductor is connected to a ground pattern of the first circuit board via a first reactance element, and the other end portion of the outer conductor is connected to the ground pattern of the first circuit board via a second reactance element.

In accordance with the above configuration, the conductive outer conductor arranged on the periphery of the conductive core wire of the coaxial cable is used as a monopole antenna with respect to the second power supply section. Consequently, it is possible to execute two radio communication applications by using the first radio frequency section and the second radio frequency section, while the number of antennas is not increased, and namely reduction in size and in thickness is achieved.

Further, a portable radio communication device according to the invention, that has a first housing and a second housing which are coupled to each other so as to be opened and closed, includes a first circuit board provided in the first housing, a second circuit board provided in the second housing, a first radio frequency section provided on the first circuit board, a second radio frequency section provided on either one of the first circuit board and the second circuit board, a first power supply section that supplies power from the first radio frequency section, a second power supply section that supplies power from the second radio frequency section, an antenna element provided in the second housing, and a coaxial cable that electrically connects the first power supply section to the antenna element. The coaxial cable has a conductive core wire and a conductive outer conductor arranged on a periphery of the core wire, the first power supply section supplies the power to the core wire of the coaxial cable, the second power supply section supplies the power to the outer conductor of the coaxial cable, and one end portion of the outer conductor is connected to a ground pattern of the first circuit board via a first reactance element and the other end portion of the outer conductor is connected to a ground pattern of the second circuit board via a second reactance element.

In accordance with the above configuration, also in the portable radio communication device having the folding structure, two radio communication applications can be executed by using the first radio frequency section and the second radio frequency section, while the number of antennas is not increased, and namely reduction in size and in thickness can be achieved.

Meanwhile, by directly connecting the other end portion of the outer conductor of the coaxial cable to the ground pattern of the second circuit board, the outer conductor of the coaxial cable can be used as a dipole antenna with respect to the second power supply device.

In addition, in the above configuration, the portable radio communication device includes a hinge section that couples the first housing and the second housing to each other so as to allow them to be rotatable. The hinge section has a conductive rotation section, and the coaxial cable is separated from the rotation section at a distance equal to or greater than a predetermined distance.

In accordance with the above configuration, since the coaxial cable and the rotation section are separated from one another at a distance equal to or greater than the predetermined distance, it is possible to suppress influence of the conductive rotation section to the coaxial cable. Meanwhile, it is preferable that the distance between the coaxial cable and the rotation section is equal to or greater than a value of one-fifteenth of a used frequency λ.

### Advantage of the Invention

In accordance with the invention, since the conductive outer conductor arranged on the periphery of the conductive core wire of the coaxial cable is used as the antenna with respect to the second power supply section, it is possible to install a plurality of radio communication applications on the portable radio communication device, while the number of antennas is not increased, and namely reduction in size and in thickness is achieved.

### BRIEF DESCRIPTION OF THE DRAWINGS

FIG. 1 is a block diagram showing a brief structure of a portable radio communication device according to an embodiment 1 of the invention.

FIG. 2 is a vertical cross sectional view showing a structure of a coaxial cable.

FIG. 3 is a block diagram showing a brief structure of a portable radio communication device according to an embodiment 2 of the invention.

FIG. 4 is an explanatory view showing a relationship in distance between a rotation section of a hinge and the coaxial cable.

FIG. 5 is a block diagram showing a brief structure of a portable radio communication device according to an embodiment 3 of the invention.

FIG. 6 is a schematic view showing a current distribution on a first circuit board and a second circuit board during an operating time of the portable radio communication device according to the embodiment 3 of the invention.

### MODE FOR CARRYING OUT THE INVENTION

Exemplary embodiments for carrying out the invention will be described below with reference to accompanying drawings.

### Embodiment 1

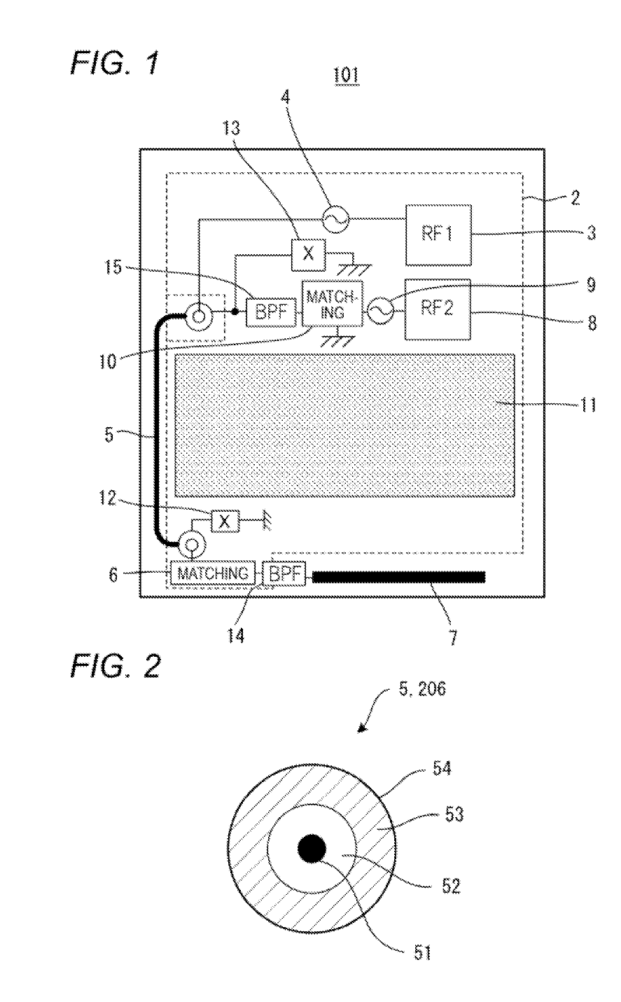

FIG. 1 is a block diagram showing a brief structure of a portable radio communication device according to an embodiment 1 of the invention. In FIG. 1, a portable radio communication device 101 is formed of a single housing.

The portable radio communication device 101 has a first circuit board 2, a battery 11 and a first antenna element 7. A first power supply section 4 described later is mounted on the first circuit board 2 and the first power supply section 4 is electrically connected to the first antenna element 7 and the first coaxial cable 5. The coaxial cable 5 is used for transmission of a radio signal and has a structure in which a conductive core wire 51, a dielectric member 52, a conductive outer conductor 53 and an insulative outer sheath 54 are sequentially laminated as shown in a vertical cross sectional view of FIG. 2.

The first circuit board 2 has, mounted thereon, a first radio frequency section (RF1) 3, the first power supply section 4 that supplies power from the first radio frequency section (RF1) 3 to the first antenna element 7, a second radio frequency section (RF2) 8, a second power supply section 9 that supplies power from the second radio frequency section (RF2) 8 to the outer conductor 53 of the first coaxial cable 5, a first matching circuit 10 that performs impedance matching between the second power supply section 9 and the outer conductor 53 of the first coaxial cable 5, a band pass filter 15 that removes an unnecessary component of a signal handled by the second radio frequency section 8, a second reactance element 13 that connects one end portion of the outer conductor 53 of the first coaxial cable 5 to a ground pattern of the first circuit board 2, a first reactance element 12 that connects the other end portion of the outer conductor 53 of the first coaxial cable 5 to the ground pattern of the first circuit board 2, a second matching circuit 6 that performs impedance matching between the first power supply section 4 and the first antenna element 7, and a band pass filter 14 that removes an unnecessary component of a signal handled by the first radio frequency section 3. It is preferable that each of the first reactance element 12 and the second reactance element 13 is formed of a combination of a capacitor and a coil.

The first power supply section 4 supplies power to the core wire 51 of the first coaxial cable 5 and the second power supply section 9 supplies power to the outer conductor 53 of the first coaxial cable 5. One end portion of the outer conductor 53 of the first coaxial cable 5 is connected to the ground pattern of the first circuit board 2 via the first reactance element 12, and the other end portion of the outer conductor 53 of the first coaxial cable 5 is connected to the ground pattern of the first circuit board 2 via the second reactance element 13. Thereby, the outer conductor 53 functions as a monopole antenna with respect to the second radio frequency section 8.

The first radio frequency section 3 executes a first radio communication application (for example, reception of a positioning signal transmitted from a GPS satellite), and the second radio frequency section 8 executes a second radio communication application (for example, radio transmission or reception in a Near Field Communication, transmission and reception in a wireless LAN, or reception of television broadcasting). The first radio frequency section 3 and the second radio frequency section 8 can be simultaneously used in a case other than a case where the used frequencies are close to each other. Meanwhile, as the case where the frequencies to be used are close to each other, a case of, for example, a Near Field Communication and a wireless LAN can be listed. A frequency band of 2.4 GHz is used in both of them.

In the portable radio communication device 101 having the above configuration, the first radio frequency section 3 performs transmission and reception of radio signals with respect to the first antenna element 7, and the second radio frequency section 8 performs transmission and reception of radio signals by using the outer conductor 53 of the first coaxial case 5 as an antenna.

Thus, in accordance with the portable radio communication device 101 of the embodiment, the second power supply section 9 supplies the power to the outer conductor 53 of the first coaxial cable 5 by using the outer conductor 53 of the first coaxial cable 5 that electrically connects the first power supply section 4 to the first antenna element 7, the one end portion of the outer conductor 53 is connected to the ground pattern of the first circuit board 2 via the first reactance element 12, the other end portion of the outer conductor 53 is connected to the ground pattern of the first circuit board 2 via the second reactance element 13, and thereby the outer conductor 53 is used as the monopole antenna with respect to the second power supply section 9. Consequently, it is possible to execute two radio communication applications by using the first radio frequency section 3 and the second radio frequency section 8, while the number of antennas is not increased, and namely reduction in size and in thickness is achieved.

### Embodiment 2

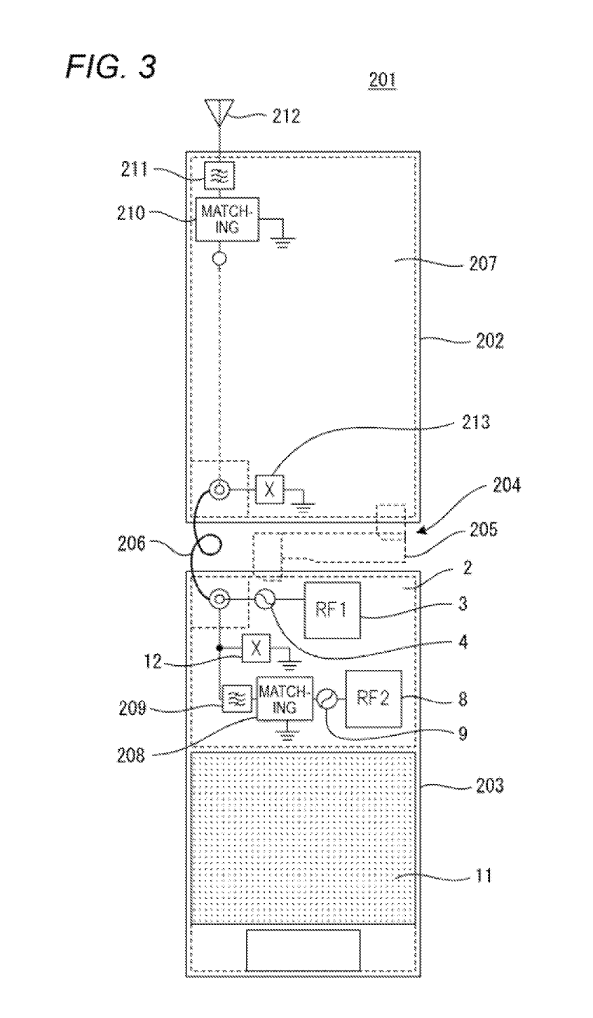

FIG. 3 is a block diagram showing a brief structure of a portable radio communication device according to an embodiment 2 of the invention. Meanwhile, sections or portions in FIG. 3 which are common to those of the portable radio communication device 101 aforementioned in FIG. 1 are denoted by the same reference symbols in FIG. 1.

While the portable radio communication device 101 of the above described embodiment 1 is formed of the first housing which is called as a straight type, a portable radio communication device 201 of the embodiment 2 is one in which a lower housing and an upper housing are coupled to each other so as to be opened and closed, which is called as a folding type.

The lower housing 203 of the portable radio communication device 201 is provided with the first circuit board 2 and the battery 11, and the upper housing 202 thereof is provided with a second circuit board 207 and a second antenna element 212. The power supply section 4 is mounted on the first circuit board 2 and the power supply section 4 is electrically connected to the second antenna element 212 which is arranged in the upper housing 202 at the upper part with a second coaxial cable 206. The second coaxial cable 206 is used for transmission of radio signals.

The first circuit board 2 in the lower housing 203 has, mounted thereon, the first radio frequency section 3, the first power supply section 4 that supplies power from the first radio frequency section 3 to the second antenna element 212, the second radio frequency section 8, the second power supply section 9 that supplies power from the second radio frequency section 8 to the outer conductor 53 of the second coaxial cable 206, a third matching circuit 208 that performs impedance matching between the second power supply section 9 and the outer conductor 53 of the second coaxial cable 206, a band pass filter 209 that removes an unnecessary component of a signal handled by the second radio frequency section 8, and a first reactance element 12 that connects one end portion of the outer conductor 53 of the second coaxial cable 206 to a ground pattern of the first circuit board 2. The band pass filter 209 is arranged between the one end portion of the outer conductor 53 of the second coaxial cable 206 and the third matching circuit 208.

The second circuit board 207 in the upper housing 202 has, mounted thereon, a fourth matching circuit 210 that performs impedance matching between the first power supply section 4 and the second antenna element 212, a band pass filter 211 that removes an unnecessary component of a signal handled by the first radio frequency section 3, and a third reactance element 213 that connects the other end portion of the outer conductor 53 of the second coaxial cable 206 to a ground pattern of the second circuit board 207.

The first power supply section 4 supplies power to the core wire 51 of the second coaxial cable 206, and the second power supply section 9 supplies power to the outer conductor 53 of the second coaxial cable 206. The one end portion of the outer conductor 53 of the second coaxial cable 206 is connected to the ground pattern of the first circuit board 2 via the first reactance element 12, and the other end portion of the outer conductor 53 is connected to the ground pattern of the second circuit board 207 via the third reactance element 213. Thereby, the outer conductor 53 functions as a monopole antenna with respect to the second radio frequency section 8.

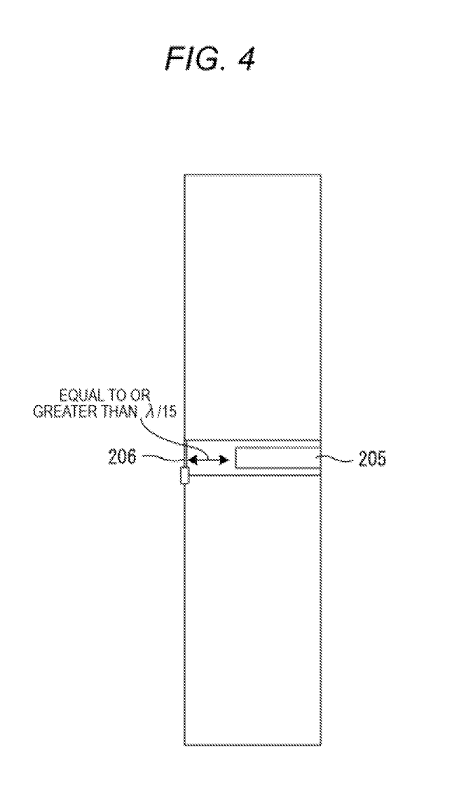

A hinge section 204 that couples the lower housing 203 and the upper housing 202 to each other so as to allow them to be rotatable, has a conductive rotation section 205. In a case where the rotation section 205 is connected to the ground pattern of the first circuit board 2 and the ground pattern of the second circuit board 207, the second coaxial cable 206 and the rotation section 205 are arranged so as to be separated from one another at a distance equal to or greater than a predetermined distance (i.e., a distance corresponding to one-fifteenth of a used frequency λ) so that the outer conductor 53 of the second coaxial cable 206 is not influenced thereby. A positional relationship between the second coaxial cable 206 and the rotation section 205 is shown in FIG. 4.

In the portable radio communication device 201 having the above configuration, the first radio frequency section 3 performs transmission and reception of radio signals through the second antenna element 212 arranged in the upper housing 202, and the second radio frequency section 8 performs transmission and reception of radio signals by using the outer conductor 53 of the second coaxial cable 206 as an antenna.

In accordance with the portable radio communication device 201 of the embodiment, the second power supply section 9 supplies the power to the outer conductor 53 of the second coaxial cable 206 by using the outer conductor 53 of the second coaxial cable 206 that electrically connects the first power supply section 4 to the second antenna element 212, the one end portion of the outer conductor 53 is connected to the ground pattern of the first circuit board 2 via the first reactance element 12, the other end portion of the outer conductor 53 is connected to the ground pattern of the second circuit board 207 via the third reactance element 213, and thereby the outer conductor 53 is used as the monopole antenna with respect to the second power supply section 9. Consequently, it is possible to execute two radio communication applications by using the first radio frequency section 3 and the second radio frequency section 8, while the number of antennas is not increased, and namely reduction in size and in thickness is achieved.

### Embodiment 3

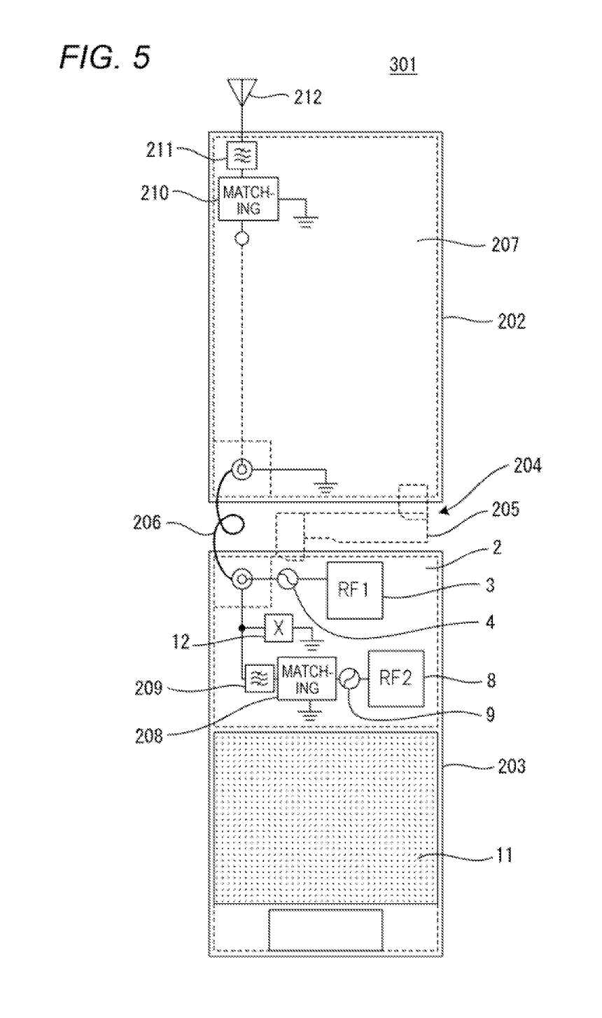

FIG. 5 is a block diagram showing a brief structure of a portable radio communication device according to an embodiment 3 of the invention. Meanwhile, sections or portions in FIG. 5 which are common to those of the portable radio communication device 201 aforementioned in FIG. 3 are denoted by the same reference symbols in FIG. 3.

The portable radio communication device 201 of the above described embodiment 2 is so configured that the other end portion of the outer conductor 53 of the second coaxial cable 206 is connected to the ground pattern of the second circuit board 207 via the third reactance element 213 and the outer conductor 53 of the second coaxial cable 206 is used as the monopole antenna with respect to the second power supply section 9. However, a portable radio communication device 301 of the embodiment 3 is so configured that the other end portion of the outer conductor 53 of the second coaxial cable 206 is directly connected to the ground pattern of the second circuit board 207, and thereby the outer conductor 53 of the second coaxial cable 206 is used as a dipole antenna with respect to the second power supply section 9.

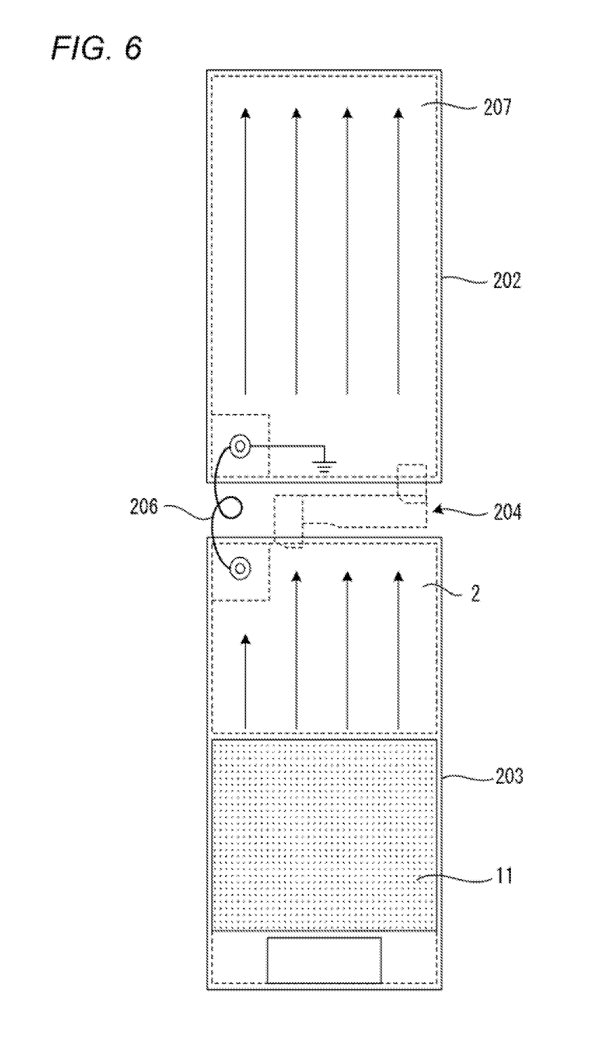

FIG. 6 is a schematic view showing a current distribution on the first circuit board 2 and the second circuit board 207 in the case where the outer conductor 53 of the second coaxial cable 206 is used as the dipole antenna with respect to the second power supply section 9, and a current flows in a direction shown by the arrows.

Thus, since the outer conductor 53 of the second coaxial cable 206 is used as the dipole antenna with respect to the second power supply section 9, it is possible to execute two applications by using the first radio frequency section 3 and the second frequency section 8, while the number of antennas is not increased, and namely reduction in size and in thickness is achieved.

While the invention is described in detail by referring to the specific embodiments, it is understood by those of ordinary skill in the art that various modifications and changes can be made without departing from the spirit and scope of the invention.

This application is based on Japanese Patent Application (JP-2010-131241) filed on Jun. 8, 2010, the contents of which are incorporated herein by reference.

### INDUSTRIAL APPLICABILITY

This invention has an effectiveness that a plurality of radio communication applications can be executed while reduction in size and in thickness is achieved. The invention can be applied to a portable radio communication device which can execute a plurality of radio communication applications such as a GPS, a Near Field Communication, a wireless LAN, a television set or the like.

### DESCRIPTION OF REFERENCE SYMBOLS AND SIGNS

101, 201, 301 portable radio communication device

2 first circuit board

3 first frequency section

4 first power supply section

5 first coaxial cable

6 second matching circuit

7 first antenna element

8 second radio frequency section

9 second power supply section

10 first matching circuit

11 battery

12 first reactance element

13 second reactance element

14, 15, 209, 211 band pass filter

51 core wire

52 dielectric member

53 outer conductor

54 outer sheath

202 upper housing

203 lower housing

204 hinge section

205 rotation section

206 second coaxial cable

207 second circuit board

210 fourth matching circuit

212 second antenna element

213 third reactance element

1. A portable radio communication device formed of a first housing, comprising:
a first circuit board provided in the first housing;
a first radio frequency section provided on the first circuit board;
a second radio frequency section provided on the first circuit board;
a first power supply section that supplies power from the first radio frequency section;
a second power supply section that supplies power from the second radio frequency section;
an antenna element provided in the first housing; and
a coaxial cable that electrically connects the first power supply section to the antenna element,
wherein the coaxial cable has a conductive core wire and a conductive outer conductor arranged on a periphery of the core wire;
wherein the first power supply section supplies the power to the core wire of the coaxial cable;
wherein the second power supply section supplies the power to the outer conductor of the coaxial cable; and
wherein one end portion of the outer conductor is connected to a ground pattern of the first circuit board via a first reactance element, and the other end portion of the outer conductor is connected to the ground pattern of the first circuit board via a second reactance element.

2. A portable radio communication device having a first housing and a second housing which are coupled to each other so as to be opened and closed, comprising:
a first circuit board provided in the first housing;
a second circuit board provided in the second housing;
a first radio frequency section provided on the first circuit board;
a second radio frequency section provided on either one of the first circuit board and the second circuit board;
a first power supply section that supplies power from the first radio frequency section;
a second power supply section that supplies power from the second radio frequency section;
an antenna element provided in the second housing; and
a coaxial cable that electrically connects the first power supply section to the antenna element,
wherein the coaxial cable has a conductive core wire and a conductive outer conductor arranged on a periphery of the core wire;
wherein the first power supply section supplies the power to the core wire of the coaxial cable;
wherein the second power supply section supplies the power to the outer conductor of the coaxial cable; and
wherein one end portion of the outer conductor is connected to a ground pattern of the first circuit board via a reactance element.

3. A portable radio communication device having a first housing and a second housing which are coupled to each other so as to be opened and closed, comprising:
a first circuit board provided in the first housing;
a second circuit board provided in the second housing;
a first radio frequency section provided on the first circuit board;
a second radio frequency section provided on either one of the first circuit board and the second circuit board;
a first power supply section that supplies power from the first radio frequency section;
a second power supply section that supplies power from the second radio frequency section;
an antenna element provided in the second housing; and
a coaxial cable that electrically connects the first power supply section to the antenna element,
wherein the coaxial cable has a conductive core wire and a conductive outer conductor arranged on a periphery of the core wire;
wherein the first power supply section supplies the power to the core wire of the coaxial cable;
wherein the second power supply section supplies the power to the outer conductor of the coaxial cable; and
wherein one end portion of the outer conductor is connected to a ground pattern of the first circuit board via a first reactance element, and the other end portion of the outer conductor is connected to a ground pattern of the second circuit board via a second reactance element.

4. The portable radio communication device according to claim 2, further comprising:
a hinge section that couples the first housing and the second housing to each other so as to allow the first housing and the second housing to be rotatable,
wherein the hinge section has a conductive rotation section; and
wherein the coaxial cable is separated from the rotation section at a distance equal to or greater than a predetermined distance.

5. The portable radio communication device according to claim 1, wherein one end portion of the core wire of the coaxial cable is connected to the antenna element via a third reactance element; and
wherein the other end portion of the core wire of the coaxial cable is connected to the first power supply section via a fourth reactance element.

6. The portable radio communication device according to claim 5, wherein each of the third reactance element and the fourth reactance element is formed of a circuit that cuts off a radio frequency of the second radio frequency section.

7. The portable radio communication device according to claim 3, further comprising:
a hinge section that couples the first housing and the second housing to each other so as to allow the first housing and the second housing to be rotatable,
wherein the hinge section has a conductive rotation section; and
wherein the coaxial cable is separated from the rotation section at a distance equal to or greater than a predetermined distance.

8. The portable radio communication device according to claim 2, wherein one end portion of the core wire of the coaxial cable is connected to the antenna element via a third reactance element; and
wherein the other end portion of the core wire of the coaxial cable is connected to the first power supply section via a fourth reactance element.

9. The portable radio communication device according to claim 8, wherein each of the third reactance element and the fourth reactance element is formed of a circuit that cuts off a radio frequency of the second radio frequency section.

10. The portable radio communication device according to claim 3, wherein one end portion of the core wire of the coaxial cable is connected to the antenna element via a third reactance element; and
wherein the other end portion of the core wire of the coaxial cable is connected to the first power supply section via a fourth reactance element.

11. The portable radio communication device according to claim 10, wherein each of the third reactance element and the fourth reactance element is formed of a circuit that cuts off a radio frequency of the second radio frequency section.
